(19) United States
(12) Patent Application Publication
(10) Pub. No.: US 2007/0132531 A1
(43) Pub. Date: Jun. 14, 2007

(54) Two pole circuit interrupter employing a single arc fault or ground fault trip circuit

(75) Inventor: Robert T. Elms, Monroeville, PA (US)

Correspondence Address: MARTIN J. MORAN, ESQ.;Eaton Electrical, Inc., Technology & Quality Center, 170 Industry Drive, RIDC Park West, Pittsburgh, PA, 15275-1032, US

(73) Assignee: EATON CORPORATION

(21) Appl. No.: 11/300,124

(22) Filed: Dec. 14, 2005

(51) Int. Cl. H01H 73/00

(52) U.S. Cl. 335/18

(57) ABSTRACT

An arc fault circuit breaker includes a housing and two poles therein. Each of the poles includes separable contacts, an operating mechanism structured to open and close the separable contacts, and a thermal/magnetic trip mechanism cooperating with the operating mechanism to trip open the separable contacts. An arc fault trip circuit cooperates with the operating mechanisms to trip open the separable contacts of the two poles whenever an arc fault is detected by the arc fault trip circuit. A shunt is electrically connected in series with a line conductor and a series RC circuit couples a current signal from the shunt to an arc fault trip mechanism. Alternatively, first and second shunts are electrically connected in series with first and second load neutral conductors, and first and second series RC circuits couple first and second current signals from the first and second shunts, respectively, to the arc fault trip mechanism.

### BACKGROUND OF THE INVENTION

1. Field of the Invention

This invention pertains generally to circuit interrupters and, more particularly, to two pole circuit interrupters, such as two pole arc fault or ground fault circuit breakers.

2. Background Information

Circuit interrupters include, for example, circuit breakers, contactors, motor starters, motor controllers, other load controllers and receptacles having a trip mechanism. Circuit breakers are generally old and well-known in the art. Examples of circuit breakers are disclosed in U.S. Pat. Nos. 5,260,676; and 5,293,522.

Circuit breakers are used to protect electrical circuitry from damage due to an overcurrent condition, such as an overload condition or a relatively high level short circuit or fault condition. In small circuit breakers, commonly referred to as miniature circuit breakers, used for residential and light commercial applications, such protection is typically provided by a thermal-magnetic trip device. This trip device includes a bimetal, which is heated and bends in response to a persistent overcurrent condition. The bimetal, in turn, unlatches a spring powered operating mechanism, which opens the separable contacts of the circuit breaker to interrupt current flow in the protected power system. An armature, which is attracted by the sizable magnetic forces generated by a short circuit or fault, also unlatches, or trips, the operating mechanism.

In many applications, the miniature circuit breaker also provides ground fault protection. Typically, an electronic circuit detects leakage of current to ground and generates a ground fault trip signal. This trip signal energizes a shunt trip solenoid, which unlatches the operating mechanism, typically through actuation of the thermal-magnetic trip device. See, for example, U.S. Pat. Nos. 5,260,676; and 5,293,522.

Recently, there has been considerable interest in also providing protection against arc faults. Arc faults are intermittent high impedance faults which can be caused, for instance, by worn insulation between adjacent conductors, by exposed ends between broken conductors, by faulty connections, and in other situations where conducting elements are in close proximity. Because of their intermittent and high impedance nature, arc faults do not generate currents of either sufficient instantaneous magnitude or sufficient average RMS current to trip the conventional circuit interrupter. Even so, the arcs can cause damage or start a fire if they occur near combustible material. It is not practical to simply lower the pick-up currents on conventional circuit breakers, as there are many typical loads, which draw similar currents and would, therefore, cause nuisance trips. Consequently, separate electrical circuits have been developed for responding to arc faults. See, for example, U.S. Pat. Nos. 5,224,006; and 5,691,869.

There is a need for a duplex (twin) arc fault circuit interrupter (AFCI), such as a duplex (twin) arc fault circuit breaker. Due to the relatively small size of many single-pole circuit breakers, the use of two AFCI trip circuits is prohibitive based upon both power dissipation and packaging constraints.

Accordingly, there is room for improvement in arc fault circuit interrupters.

### SUMMARY OF THE INVENTION

These needs and others are met by the present invention, which employs a single arc fault circuit interrupter (AFCI) or ground fault circuit interrupter (GFCI) trip circuit in combination with two poles of a duplex or twin AFCI or GFCI. Each one of the two poles of the duplex or twin AFCI or GFCI shares a common line conductor and a common neutral conductor. The single AFCI or GFCI trip circuit is employed in order to permit both poles to trip together whenever an arc fault or ground fault is electronically detected.

In accordance with one aspect of the invention, an arc fault circuit interrupter comprises: a housing; two poles in the housing, each of the poles comprising: separable contacts, an operating mechanism structured to open and close the separable contacts, and a trip mechanism cooperating with the operating mechanism to trip open the separable contacts; and a single arc fault trip circuit cooperating with the operating mechanisms of the two poles to trip open the separable contacts of the two poles whenever an arc fault is detected by the single arc fault trip circuit.

The single arc fault trip circuit may comprise a trip solenoid cooperating with the operating mechanisms of the two poles to contemporaneously trip open the separable contacts of the two poles.

As another aspect of the invention, an arc fault circuit interrupter comprises: a housing; two poles in the housing, each of the poles comprising: separable contacts comprising a line side and a load side, an operating mechanism structured to open and close the separable contacts, and a trip mechanism cooperating with the operating mechanism to trip open the separable contacts; a line conductor including a line current, the line conductor being electrically interconnected with the line side of the separable contacts of the two poles; a neutral conductor; a first load conductor electrically interconnected with the load side of the separable contacts of one of the two poles; a second load conductor electrically interconnected with the load side of the separable contacts of the other one of the two poles; a first load neutral conductor electrically interconnected with the neutral conductor, the first load neutral conductor including a first neutral current; a second load neutral conductor electrically interconnected with the neutral conductor, the second load neutral conductor including a second neutral current; a single arc fault trip circuit cooperating with the operating mechanisms of the two poles to trip open the separable contacts of the two poles, the single arc fault trip circuit comprising: (a) a shunt electrically connected in series with the line conductor and structured to sense the line current thereof, or (b) a first shunt electrically connected in series with the first load neutral conductor and structured to sense the first neutral current and a second shunt electrically connected in series with the second load neutral conductor and structured to sense the second neutral current, wherein the two poles trip together whenever an arc fault is detected by the single arc fault trip circuit.

The single arc fault trip circuit may comprise the shunt electrically connected in series with the line conductor, the shunt electrically connected in series with the line conductor may include a current signal, and the single arc fault trip circuit may further comprise an arc fault trip mechanism and a series RC circuit coupling the current signal to the arc fault trip mechanism.

The neutral conductor may be electrically interconnected with the single arc fault trip circuit, and the single arc fault trip circuit may further comprise a trip solenoid cooperating with the operating mechanisms of the two poles to trip open the separable contacts of the two poles and a contact controlled by the trip solenoid, the contact being structured to disconnect the neutral conductor from the single arc fault trip circuit.

The single arc fault trip circuit may comprise the first shunt and the second shunt. The first shunt may include a first current signal, the second shunt may include a second current signal, and the single arc fault trip circuit may further comprise an arc fault trip mechanism, a first series RC circuit coupling the first current signal to the arc fault trip mechanism and a second series RC circuit coupling the second current signal to the arc fault trip mechanism.

The line conductor may be electrically interconnected with the single arc fault trip circuit, and the single arc fault trip circuit may further comprise a trip solenoid cooperating with the operating mechanisms of the two poles to trip open the separable contacts of the two poles and a contact controlled by the trip solenoid, the contact being structured to disconnect the line conductor from the single arc fault trip circuit.

The single arc fault trip circuit may be structured to provide backfeed protection.

The line conductor may be electrically interconnected with the single arc fault trip circuit, and the single arc fault trip circuit may further comprise a contact structured to disconnect the line conductor from the single arc fault trip circuit when the single arc fault trip circuit trips open the two poles.

The single arc fault trip circuit may further comprise a trip solenoid cooperating with the operating mechanisms of the two poles to contemporaneously trip open the separable contacts of the two poles.

The trip solenoid may comprise a first flag structured to trip open one of the two poles and a second trip flag structured to trip open the other one of the two poles. The first flag may pull or push the one of the two poles to trip the one of the two poles, and the second trip flag may pull or push the other of the two poles to trip the other of the two poles.

The single arc fault trip circuit may be normally powered from the line conductor and the neutral conductor, and the single arc fault trip circuit may be unpowered after the single arc fault trip circuit cooperates with the operating mechanisms of the two poles to trip open the separable contacts of the two poles.

The single arc fault trip circuit may be powered from the line conductor and the neutral conductor when at least one of the two poles is not tripped.

As another aspect of the invention, a ground fault circuit interrupter comprises: a housing; two poles in the housing, each of the poles comprising: separable contacts, an operating mechanism structured to open and close the separable contacts, and a trip mechanism cooperating with the operating mechanism to trip open the separable contacts; and a single ground fault trip circuit cooperating with the operating mechanisms of the two poles to trip open the separable contacts of the two poles whenever a ground fault is detected by the single ground fault trip circuit.

### BRIEF DESCRIPTION OF THE DRAWINGS

A full understanding of the invention can be gained from the following description of the preferred embodiments when read in conjunction with the accompanying drawings in which:

FIG. 1 is a block diagram of an arc fault circuit interrupter in accordance with the present invention.

FIGS. 2 and 3 are block diagrams of arc fault circuit breakers in accordance with embodiments of the invention.

FIG. 4 is a simplified top plan view of the arc fault circuit breaker of FIG. 2.

FIG. 5 is a block diagram of the trip solenoid and operating mechanisms of FIG. 4.

FIG. 6 is a block diagram in schematic form of the arc fault circuit breaker of FIG. 2.

FIG. 7 is a block diagram in schematic form of the arc fault circuit breaker of FIG. 3.

### DESCRIPTION OF THE PREFERRED EMBODIMENTS

As employed herein, the statement that a part is “electrically interconnected with” one or more other parts shall mean that the parts are directly electrically connected together or are electrically connected together through one or more electrical conductors or generally electrically conductive intermediate parts. Further, as employed herein, the statement that a part is “electrically connected to” one or more other parts shall mean that the parts are directly electrically connected together or are electrically connected together through one or more electrical conductors.

The present invention is described in association with arc fault circuit breakers, although the invention is applicable to a wide range of circuit interrupters for arc fault and/or ground fault applications.

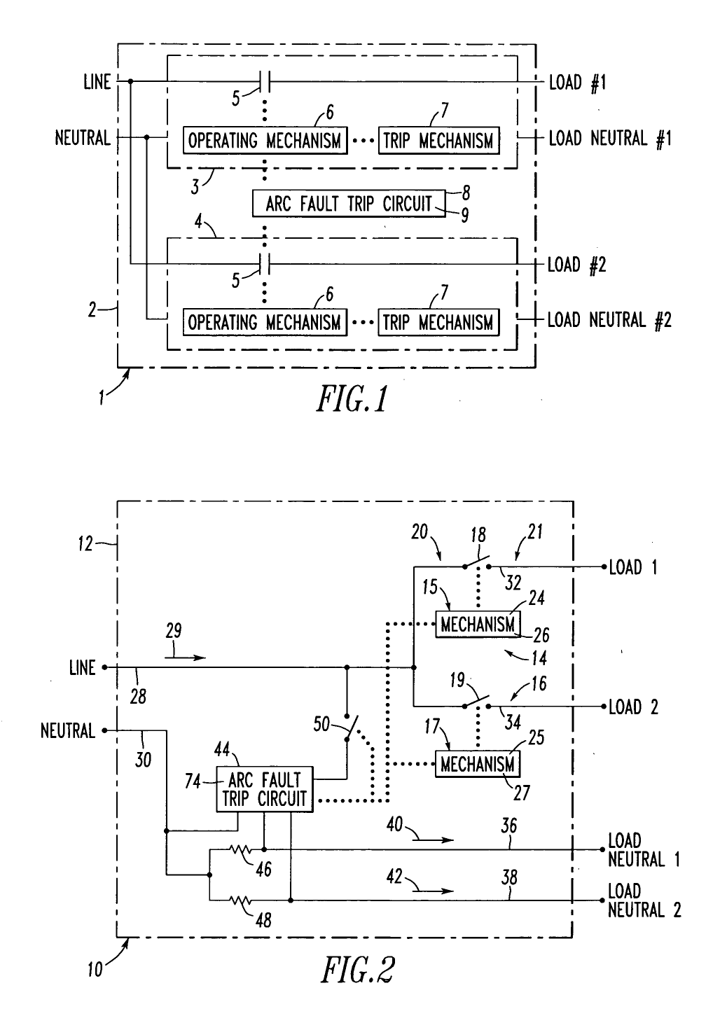

FIG. 1 shows an arc fault circuit interrupter 1 including a housing 2 and two poles 3,4 in the housing 2. Each of the poles 3,4 includes separable contacts 5, an operating mechanism 6 structured to open and close the separable contacts 5, and a trip mechanism 7 cooperating with the operating mechanism 6 to trip open the separable contacts 5. A single arc fault trip circuit 8 cooperates with the operating mechanisms 6 of the two poles 3,4 to trip open the separable contacts 5 of such poles whenever an arc fault is detected by the single arc fault trip circuit 8.

### EXAMPLE 1

The single arc fault trip circuit 8 may include a trip solenoid 9 cooperating with the operating mechanisms 6 of the two poles 3,4 to contemporaneously trip open the separable contacts 5 of such poles.

### EXAMPLE 2

The example trip mechanisms of the two poles 3,4 are thermal/magnetic trip mechanisms 7, although any suitable (non-arc fault) trip mechanism may be employed.

### EXAMPLE 3

Referring to FIG. 2, an arc fault circuit interrupter, such as the example arc fault circuit breaker 10, includes a housing 12 and two poles 14,16 in the housing. Each of the poles 14,16 includes separable contacts 18,19, an operating mechanism 24,25 structured to open and close the corresponding separable contacts 18,19, and a trip mechanism 26,27 cooperating with the corresponding operating mechanism 24,25 to trip open the corresponding separable contacts 18,19, respectively. For convenience of illustration, the operating mechanism 24 and trip mechanism 26 are shown together as mechanism 15, and the operating mechanism 25 and trip mechanism 27 are shown together as mechanism 17. The separable contacts 18,19 have a line side 20 and a load side 21. The circuit breaker 10 further includes a line conductor 28, which has a line current 29, electrically interconnected with the line side 20 of the separable contacts 18,19, a neutral conductor 30, a first load conductor 32 electrically interconnected with the load side 21 of the separable contacts 18, a second load conductor 34 electrically interconnected with the load side 21 of the separable contacts 19, a first load neutral conductor 36 electrically interconnected with the neutral conductor 30, and a second load neutral conductor 38 electrically interconnected with the neutral conductor 30. The first and second load neutral conductors 36,38 includes first and second neutral currents 40,42, respectively. A single arc fault trip circuit 44 cooperates with the operating mechanisms 24,25 of the two poles 14,16 to trip open the separable contacts 18,19, respectively. The single arc fault trip circuit 44 includes a first shunt 46 having a suitable low impedance electrically connected in series with the first load neutral conductor 36 and structured to sense the first neutral current 40, and a second shunt 48 having a suitable low impedance electrically connected in series with the second load neutral conductor 38 and structured to sense the second neutral current 42. In turn, the shunts 46,48 are electrically interconnected with the neutral conductor 30. The two poles 14,16 trip together whenever an arc fault is detected by the single arc fault trip circuit 44.

### EXAMPLE 4

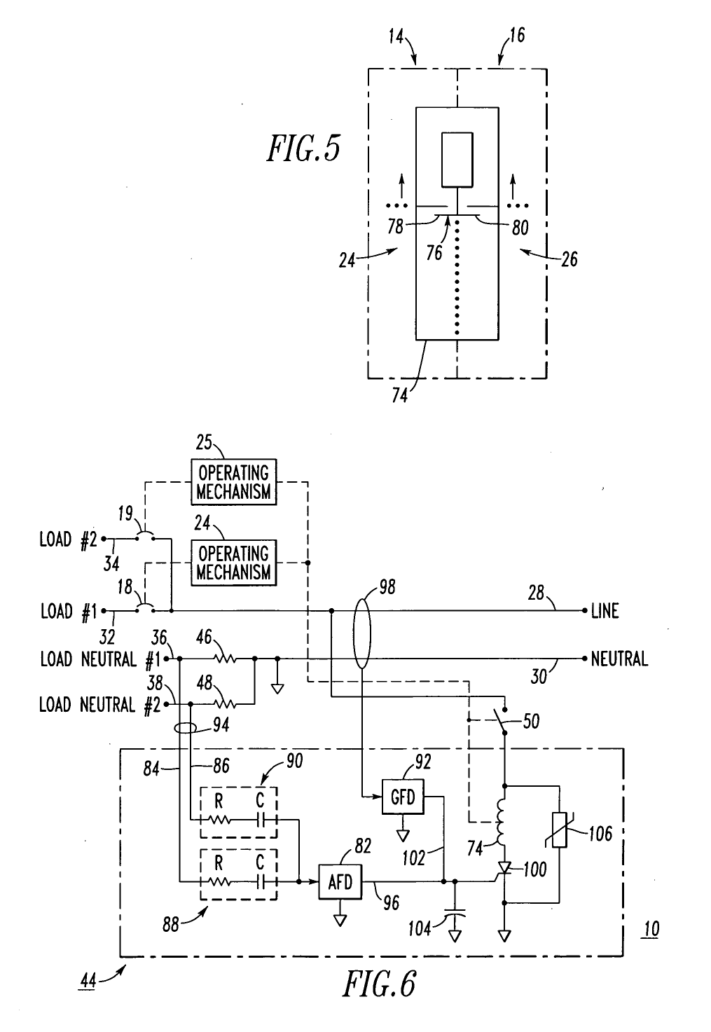

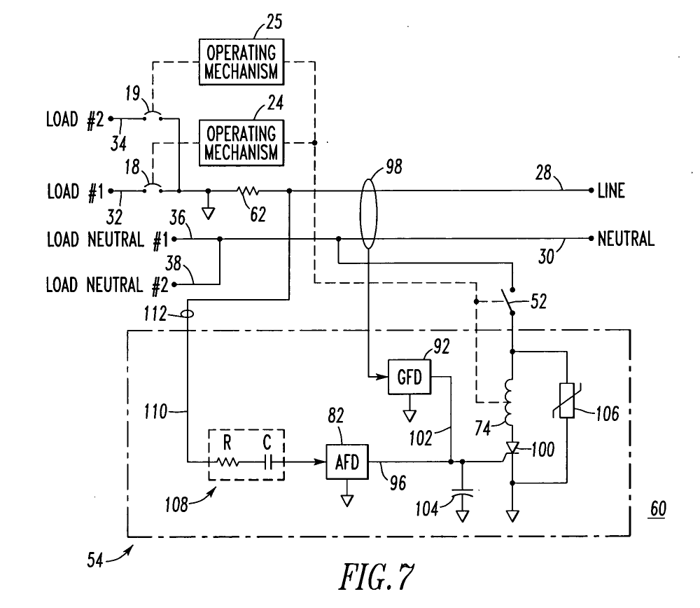

Preferably, the single arc fault trip circuit 44 is structured to provide backfeed protection as will be discussed in greater detail, below, in connection with FIG. 6. Briefly, the arc fault trip circuit 44 cannot place a load on the line conductor 28 whenever the contact 50 of FIG. 2 is open. In contrast, as will be discussed below in connection with FIG. 7, the contact 52 disconnects the neutral conductor 30 and not the line conductor 28 from the single arc fault trip circuit 54.

### EXAMPLE 5

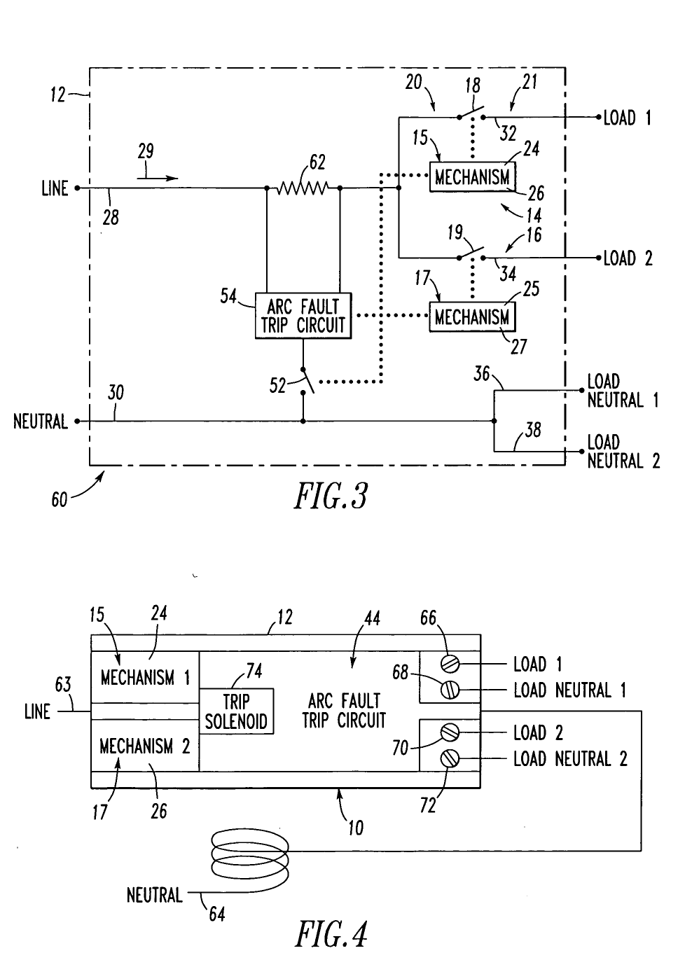

FIG. 3 shows another arc fault circuit interrupter, such as the example arc fault circuit breaker 60, which is the same as or similar to the arc fault circuit breaker 10 of FIG. 2, except as was discussed above in connection with Example 4 and except as will be described. In this example, the single arc fault trip circuit 54 includes a shunt 62 electrically connected in series with the line conductor 28 and structured to sense the line current 29 thereof. Also, the first and second load neutral conductors 36,38 are electrically connected to the neutral conductor 30. As was discussed above in connection with the arc fault circuit breaker 10 of FIG. 2, the two poles 14,16 trip together whenever an arc fault is detected by the single arc fault trip circuit 54.

### EXAMPLE 6

The single arc fault trip circuits 44,54 of FIGS. 2 and 3 are normally powered from the line conductor 28 and the neutral conductor 30. For the operating mechanisms 24,25 (e.g., as shown in FIG. 2) being in the common trip position, the arc fault trip circuits 44,54 are unpowered when the separable contacts 18,19 of the respective poles 14,16 are tripped open. Otherwise, the arc fault trip circuits 44,54 are powered from the line and neutral conductors 28,30 when one or both of the poles 14,16 are closed and not tripped.

### EXAMPLE 7

The trip mechanisms 26,27 (e.g., as shown in FIG. 2) of the two poles 14,16 are thermal/magnetic trip mechanisms.

### EXAMPLE 8

The single arc fault trip circuits 44,54 may further include a ground fault trip circuit as will be discussed, below, in connection with FIGS. 6 and 7.

### EXAMPLE 9

The two poles 14,16 of FIGS. 2 and 3 operate independently and have independent mechanisms 15,17.

### EXAMPLE 10

FIG. 4 shows the arc fault circuit breaker 10 of FIG. 2. Conductors 63 (e.g., line stab) and 64 (e.g., neutral pigtail) are provided from the ends of the housing 12 for electrically connecting the circuit breaker 10 to a power source (not shown). Terminals 66 (load 1) and 68 (load neutral 1) at one end of the housing 12 electrically connect the circuit breaker 10 to a first load (not shown), and terminals 70 (load 2) and 72 (load neutral 2) at the same housing end electrically connect the circuit breaker 10 to a second load (not shown). The arc fault trip circuit 44 includes a trip solenoid 74, which cooperates with the two pole mechanisms 15 and 17 (e.g., the operating mechanisms 24,26) to contemporaneously trip open the respective separable contacts 18 and 19 (FIG. 2).

Although not shown, the arc fault circuit breaker 60 of FIG. 3 may employ the same or similar trip solenoid 74 and the conductors 63,64 and terminals 66,68,70,72.

### EXAMPLE 11

FIG. 5 shows the trip solenoid 74 and the operating mechanisms 24,26 of FIG. 4. The single trip solenoid 74 employs a dual flag 76 having two flags or sides 78,80 each of which trips a corresponding one of the poles 14,16 (FIG. 2). For example, a corresponding flag side pulls or pushes to trip the corresponding pole. In particular, the first flag 78 is structured to trip open the pole 14 and the second flag 80 is structured to trip open the other pole 16. The first flag 78 may pull or push the operating mechanism 24 to trip the pole 14 and the second flag 80 may pull or push the other operating mechanism 26 to trip the other pole 16.

### EXAMPLE 12

FIG. 6 shows the arc fault circuit breaker 10 of FIG. 2 in which the single arc fault trip circuit 44 includes the first shunt 46, the second shunt 48 and an arc fault trip mechanism, such as the arc fault detector (AFD) 82. The shunts 46,48 are disposed in series with the respective neutral conductors 36,38 and couple two signals 84,86 from such shunts by two series RC circuits 88,90, respectively, into the trip circuit 44. The first shunt 46 includes the first current signal 84, and the second shunt 48 includes the second current signal 86. The first series RC circuit 88 couples the first arc fault current signal 84 to the AFD 82, and the second series RC circuit 90 couples the second arc fault current signal 86 to the AFD 82. The first and second shunts 46,48 are electrically connected to the common neutral conductor 30, such that the single arc fault trip circuit 44 senses both the first and second neutral currents 40,42 (FIG. 2).

The line conductor 28 is electrically interconnected with the single arc fault trip circuit 44 through the contact 50. The trip solenoid 74 cooperates with the operating mechanisms 24,25 of the two poles 14,16 (FIG. 2) to trip open the separable contacts 18,19, respectively. The contact 50, which is controlled by the trip solenoid 74 that trips both of the poles 14,16, is structured to disconnect the line conductor 28 from the single arc fault trip circuit 44 when it trips open such poles. This provides backfeed protection since the contact 50 electrically disconnects the line conductor 28 from the trip circuit 44 when the trip solenoid 74 is energized.

In this example, the arc fault trip circuit 44 includes both the AFD 82 and a ground fault detector (GFD) 92. The AFD 82 may be, for instance, of the type which detects the step increases in current which occur each time an arc is struck, although other types of arc fault detectors could also be used. Suitable arc fault detectors are disclosed, for instance, in U.S. Pat. No. 5,224,006, with a preferred type described in U.S. Pat. No. 5,691,869, which is incorporated by reference herein. In accordance with an important aspect of the invention, the AFD 82 senses the load neutral currents 40,42 (FIG. 2) by monitoring the voltages across the shunts 46,48 through two leads 94 in order to sense arc fault current conditions in the two load neutral conductors 36,38. As described in U.S. Pat. No. 5,691,869 for a single pole, the AFD 82 includes circuitry, which generates a pulse in response to each step change in current. The pulse signal is integrated with the result of the integration being attenuated over time.

When the time attenuated accumulation of the pulses reaches a selected level, the AFD 82 generates at its output an arc fault trip signal 96, which is active in response to arc fault(s) associated with one (or both) of the load neutral currents 40,42 (FIG. 2). In turn, the signal 96 is combined with the output signal of the GFD 92 and is employed to actuate the operating mechanisms 24,25 and open the separable contacts 18,19 in response to the fault.

The GFD 92 may be of the well-known dormant oscillator type in which case it utilizes at least one sensing coil, such as 98, to detect both line-to-ground and neutral-to-ground fault current conditions. If the AFD 82 detects an arc fault, the trip signal 96 is generated, which turns on a switch, such as the silicon controlled rectifier (SCR) 100, to energize the trip solenoid 74. When the GFD 92 detects a ground fault, it generates at its output a ground fault trip signal 102, which is active in response to the ground fault. The ground fault trip signal 102 is “ORed” with the arc fault trip signal 96 (i.e., an “OR” function of the outputs of the GFD 92 and the AFD 82), such that the combination of the signals 96,102 turns the SCR 100 on, energizes the trip solenoid 74 and, thereby, actuates the operating mechanisms 24,25 to open the separable contacts 18,19 in response to the arc fault or ground fault. A capacitor 104 protects the gate of the SCR 100 from voltage spikes and false tripping due to noise. An MOV or transorb 106 protects the trip solenoid 74 and SCR 100 from overvoltage conditions.

Both the AFD 82 and the GFD 92 may have test circuits (not shown). Examples of such test circuits are disclosed in U.S. Pat. Nos. 5,982,593; and 6,707,651, which are incorporated by reference herein.

### EXAMPLE 13

FIG. 7 shows the arc fault circuit breaker 60 of FIG. 3 in which the single arc fault trip circuit 54 includes the shunt 62 in series with the line conductor 28, the arc fault trip mechanism, such as the arc fault detector (AFD) 82, and a series RC circuit 108 coupling a current signal 110 on lead 112 from the shunt 62 to the AFD 82. In this example, the one series RC circuit 108 brings the arc fault current signal 110 to the single arc fault trip circuit 54.

The neutral conductor 30 is electrically interconnected with the single arc fault trip circuit 44 through the contact 52. The trip solenoid 74 cooperates with the operating mechanisms 24,25 of the two poles 14,16 (FIG. 3) to trip open the separable contacts 18,19. The contact 52, which is controlled by the trip solenoid 74 that trips both of the poles 14,16, is structured to disconnect the neutral conductor 30 from the single arc fault trip circuit 54. In this example, the single arc fault trip circuit 54 senses the line current 29 (FIG. 3). The signal 110 from the single shunt 62 is coupled into the arc fault trip circuit 54 by the series RC circuit 108.

### EXAMPLE 14

The single trip circuits 44,54 may be employed by two-pole circuit interrupters for ground fault applications.

Although an analog AFD 82 is disclosed, it will be appreciated that a combination of one or more of analog, digital and/or processor-based circuits may be employed.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. An arc fault circuit interrupter comprising:
a housing;
two poles in said housing, each of said poles comprising:
separable contacts,
an operating mechanism structured to open and close said separable contacts, and
a trip mechanism cooperating with said operating mechanism to trip open said separable contacts; and
a single arc fault trip circuit cooperating with the operating mechanisms of said two poles to trip open the separable contacts of said two poles whenever an arc fault is detected by said single arc fault trip circuit.

2. The arc fault circuit interrupter of claim 1 wherein said single arc fault trip circuit comprises a trip solenoid cooperating with the operating mechanisms of said two poles to contemporaneously trip open the separable contacts of said two poles.

3. The arc fault circuit interrupter of claim 1 wherein the trip mechanisms of said two poles are thermal/magnetic trip mechanisms.

4. An arc fault circuit interrupter comprising:
a housing;
two poles in said housing, each of said poles comprising:
separable contacts comprising a line side and a load side,
an operating mechanism structured to open and close said separable contacts, and
a trip mechanism cooperating with said operating mechanism to trip open said separable contacts;
a line conductor including a line current, said line conductor being electrically interconnected with the line side of the separable contacts of said two poles;
a neutral conductor;
a first load conductor electrically interconnected with the load side of the separable contacts of one of said two poles;
a second load conductor electrically interconnected with the load side of the separable contacts of the other one of said two poles;
a first load neutral conductor electrically interconnected with said neutral conductor, said first load neutral conductor including a first neutral current;
a second load neutral conductor electrically interconnected with said neutral conductor, said second load neutral conductor including a second neutral current;
a single arc fault trip circuit cooperating with the operating mechanisms of said two poles to trip open the separable contacts of said two poles, said single arc fault trip circuit comprising: (a) a shunt electrically connected in series with said line conductor and structured to sense the line current thereof, or (b) a first shunt electrically connected in series with said first load neutral conductor and structured to sense said first neutral current and a second shunt electrically connected in series with said second load neutral conductor and structured to sense said second neutral current,
wherein said two poles trip together whenever an arc fault is detected by said single arc fault trip circuit.

5. The arc fault circuit interrupter of claim 4 wherein said single arc fault trip circuit comprises said shunt electrically connected in series with said line conductor; wherein said shunt electrically connected in series with said line conductor includes a current signal; and wherein said single arc fault trip circuit further comprises an arc fault trip mechanism and a series RC circuit coupling said current signal to said arc fault trip mechanism.

6. The arc fault circuit interrupter of claim 4 wherein said neutral conductor is electrically interconnected with said single arc fault trip circuit; and wherein said single arc fault trip circuit further comprises a trip solenoid cooperating with the operating mechanisms of said two poles to trip open the separable contacts of said two poles and a contact controlled by said trip solenoid, said contact being structured to disconnect said neutral conductor from said single arc fault trip circuit.

7. The arc fault circuit interrupter of claim 4 wherein said single arc fault trip circuit comprises said first shunt and said second shunt.

8. The arc fault circuit interrupter of claim 7 wherein said first shunt includes a first current signal; wherein said second shunt includes a second current signal; and wherein said single arc fault trip circuit further comprises an arc fault trip mechanism, a first series RC circuit coupling said first current signal to said arc fault trip mechanism and a second series RC circuit coupling said second current signal to said arc fault trip mechanism.

9. The arc fault circuit interrupter of claim 7 wherein said line conductor is electrically interconnected with said single arc fault trip circuit; and wherein said single arc fault trip circuit further comprises a trip solenoid cooperating with the operating mechanisms of said two poles to trip open the separable contacts of said two poles and a contact controlled by said trip solenoid, said contact being structured to disconnect said line conductor from said single arc fault trip circuit.

10. The arc fault circuit interrupter of claim 7 wherein said single arc fault trip circuit senses said first neutral current and said second neutral current.

11. The arc fault circuit interrupter of claim 7 wherein said single arc fault trip circuit is structured to provide backfeed protection.

12. The arc fault circuit interrupter of claim 4 wherein said line conductor is electrically interconnected with said single arc fault trip circuit; and wherein said single arc fault trip circuit further comprises a contact structured to disconnect said line conductor from said single arc fault trip circuit when said single arc fault trip circuit trips open said two poles.

13. The arc fault circuit interrupter of claim 4 wherein said single arc fault trip circuit further comprises a trip solenoid cooperating with the operating mechanisms of said two poles to contemporaneously trip open the separable contacts of said two poles.

14. The arc fault circuit interrupter of claim 4 wherein said trip solenoid comprises a first flag structured to trip open one of said two poles and a second trip flag structured to trip open the other one of said two poles.

15. The arc fault circuit interrupter of claim 14 wherein said first flag pulls or pushes said one of said two poles to trip said one of said two poles and said second trip flag pulls or pushes said other of said two poles to trip said other of said two poles.

16. The arc fault circuit interrupter of claim 4 wherein said single arc fault trip circuit is normally powered from said line conductor and said neutral conductor; and wherein said single arc fault trip circuit is unpowered after said single arc fault trip circuit cooperates with the operating mechanisms of said two poles to trip open the separable contacts of said two poles.

17. The arc fault circuit interrupter of claim 4 wherein said single arc fault trip circuit is powered from said line conductor and said neutral conductor when at least one of said two poles is not tripped.

18. The arc fault circuit interrupter of claim 4 wherein said arc fault circuit interrupter is an arc fault circuit breaker.

19. The arc fault circuit interrupter of claim 4 wherein the trip mechanisms of said two poles are thermal/magnetic trip mechanisms.

20. The arc fault circuit interrupter of claim 19 wherein said single arc fault trip circuit further comprises a ground fault trip circuit.

21. A ground fault circuit interrupter comprising:
a housing;
two poles in said housing, each of said poles comprising:
separable contacts,
an operating mechanism structured to open and close said separable contacts, and
a trip mechanism cooperating with said operating mechanism to trip open said separable contacts; and
a single ground fault trip circuit cooperating with the operating mechanisms of said two poles to trip open the separable contacts of said two poles whenever a ground fault is detected by said single ground fault trip circuit.
